(19) United States
(12) Patent Application Publication
(10) Pub. No.: US 2008/0271321 A1
(43) Pub. Date: Nov. 6, 2008

(54) Strawberry huller with ejector

(75) Inventors: Todd Brunner, Brooklyn, NY (US); Jim Best, Hewitt, NJ (US); Marco Perry, Brooklyn, NY (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 12/075,894

(22) Filed: Mar. 14, 2008

Related U.S. Application Data
(63) Continuation-in-part of application No. 11/799,686, filed on May 2, 2007.

(51) Int. Cl. A47J 25/00; B26B 11/00

(52) U.S. Cl. 30/113.1; 30/128

(57) ABSTRACT

A hulling device for removing the stem and leaves on small fruits, such as strawberries, the device having an ergonomic handle and a tubular cutting member, is set forth herein. The cutting member is comprised of a cutting end and is securely attached to the handle at a shoulder which assists in preventing complete coring of the fruit. The tubular cutting member having a length which is less than the length of the handle also facilitates prevention of coring edible fruit flesh from the strawberry.

### RELATED APPLICATION

The present application is a continuation-in-part of U.S. patent application Ser. No. 11/799,686, filed on May 2, 2007, the entire disclosure of which is hereby incorporated by reference.

### TECHNICAL FIELD OF THE INVENTION

The present device relates to a strawberry huller with ejector. Particularly, the present device relates to a handheld strawberry huller for quickly and easily hulling such fruit without removing an excess of edible fruit flesh.

### BACKGROUND OF THE INVENTION

There are an almost uncountable number of desserts and dishes which call for the use of fresh fruit, such as strawberries. Typically, strawberries are bought fresh from the market, cleaned and then individually sliced for use. Strawberries are somewhat unique as a fruit, because unlike fruit such as apples and pears, strawberries do not have a seedy core to remove. And, unlike fruit such as oranges, kiwi and bananas, strawberries do not have a skin or peel to remove. Unfortunately, much like grapes and cherries, fresh strawberries do have a stem that requires removal before eating.

Strawberry stems can be removed from the strawberry in a variety of ways, including the use of fingers, or by using either a strawberry corer or a strawberry huller. The use of ones' fingers can be messy, slow and unsanitary. A paring knife may also be employed to remove the stem and core from a strawberry. This is also time consuming and can waste strawberry flesh.

A strawberry corer, as described in U.S. Pat. No. 4,949,459 to Noble, U.S. Pat. No. 5,092,043 to Shirkey, and U.S. Pat. No. 5,794,344 to Poulos et al., unnecessarily remove the entire core of the strawberry. The known hullers (also known in the art as a stem plucker) are tiny tong-like devices which, when squeezed by the user, are used to grab the strawberry stem securely and then pull it off. Similar to a pairing knife, the known hullers can be slow and may remove too much of the desired strawberry flesh.

There is disclosed herein an improved strawberry huller which avoids the disadvantages of prior devices while affording additional structural and operating advantages.

### SUMMARY OF THE INVENTION

A hulling device having an ergonomic handle and a tubular cutting member is set forth herein. The cutting member is comprised of a cutting end and is attached to the handle. A discharging mechanism positioned within the tubular cutting member, and an actuator coupled to the discharging mechanism capable of moving the discharging mechanism, with the application of a force on the actuator, from a retracted position proximate the second end of the tubular cutting member to an extended position proximate the first end of the tubular cutting member. This actuation pushes the cored fruit part from the cutting tube.

In one embodiment of the device, the actuator is biased into a return position by a member, preferably a spring, such that removal of the force from the actuator returns the discharging mechanism to the retracted position.

It is an aspect of one embodiment of the huller that the tubular cutting member has a length which is less than the length of the handle. The discharging mechanism and the actuator are both preferably positioned within the handle of the device.

It is another aspect of an embodiment of the huller to provide a shoulder at the connection between the cutting end and handle, wherein the shoulder stops penetration of the food at the length of the cutting member.

It is still a further aspect of an embodiment of the present huller wherein the length of the tubular cutting member prevents the cutting member from cutting substantially through the strawberry. Preferably, the tubular cutting member is less than one and one-half inches (1½ inches) in length. Most preferably, the tubular cutting member is less than one inch in length.

Finally, it is another aspect of an embodiment of the present huller to provide an handle which sits comfortably in the user's hand. Preferably, the ergonomic handle is covered at least in part by a thermoplastic elastomer (TPE) material, such as SANTOPRENE.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the present strawberry huller;

FIG. 2 is a front view of the embodiment shown in FIG. 1;

FIG. 3 is a side view of the embodiment shown in FIG. 1;

FIG. 4 is a top view of the embodiment shown in FIG. 1;

FIG. 5 is a bottom view of the embodiment shown in FIG. 1;

FIG. 6 is a front cross-section of the embodiment of FIG. 1;

FIG. 7 is a cross-section similar to FIG. 6, showing the actuator in a depressed position;

FIG. 8 is a side cross-section of the embodiment of FIG. 1;

FIGS. 9 through 11 are perspective views of the device as it might be used to core a strawberry and eject the same.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

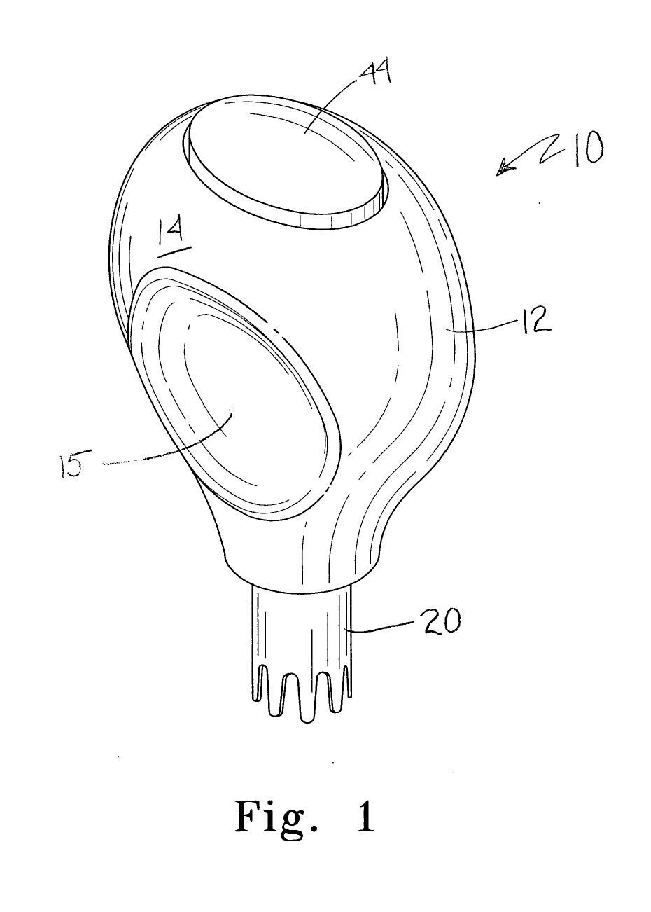

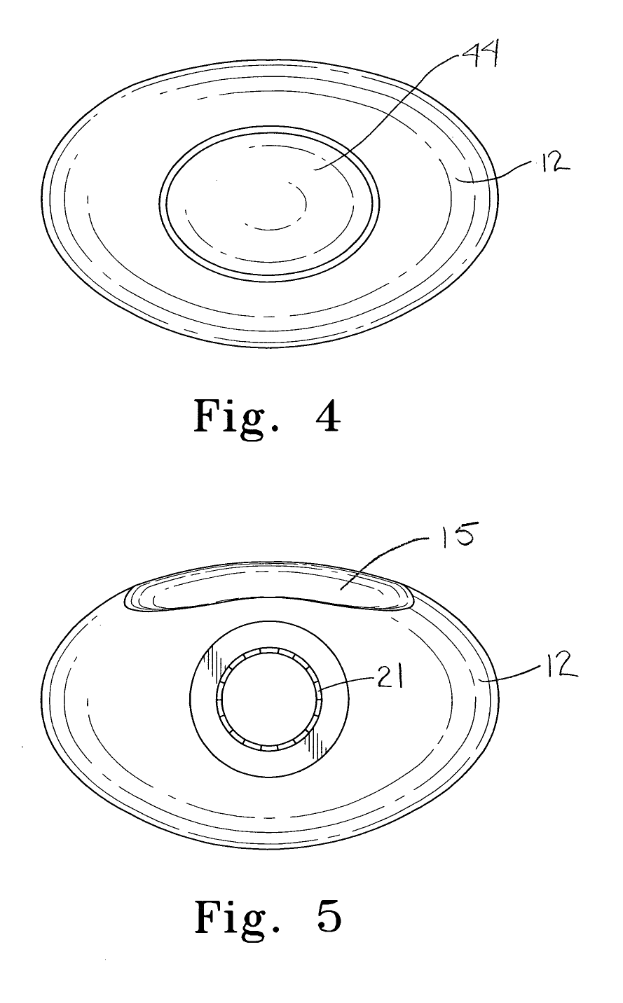

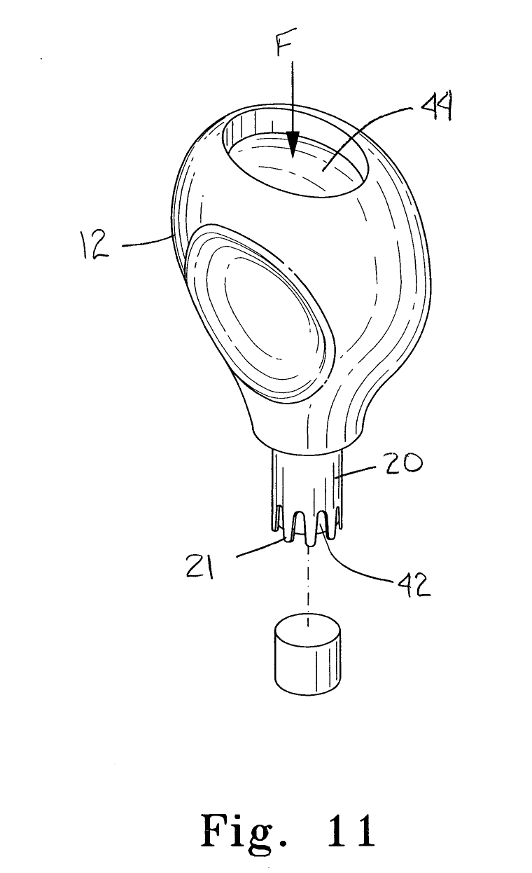

Referring to FIGS. 1-11, there is illustrated a strawberry huller, generally designated by the numeral 10. The huller 10 has an ergonomic handle 12, a cutting member 20, and an ejector mechanism for displacing the cored portion of a fruit from the cutting member 20.

As illustrated in FIGS. 1-5, the ergonomic handle 12 is preferably sized and contoured to fit comfortably within the hand of a user.

Accordingly, the handle 12 has a substantially round and bulbous body 14 with a depressed area 15 on one side. The depressed area 15 provides a suitable spot for positioning of the user's thumb during operation. The body 14 of the handle 12 is preferably molded from a rigid plastic material. However, to increase the comfort of holding the huller 10, a layer of resilient material, such as a thermoplastic elastomer (TPE), can be coated onto at least a portion, if not the entire body 14. SANTOPRENE® is a preferred material for such cushioning.

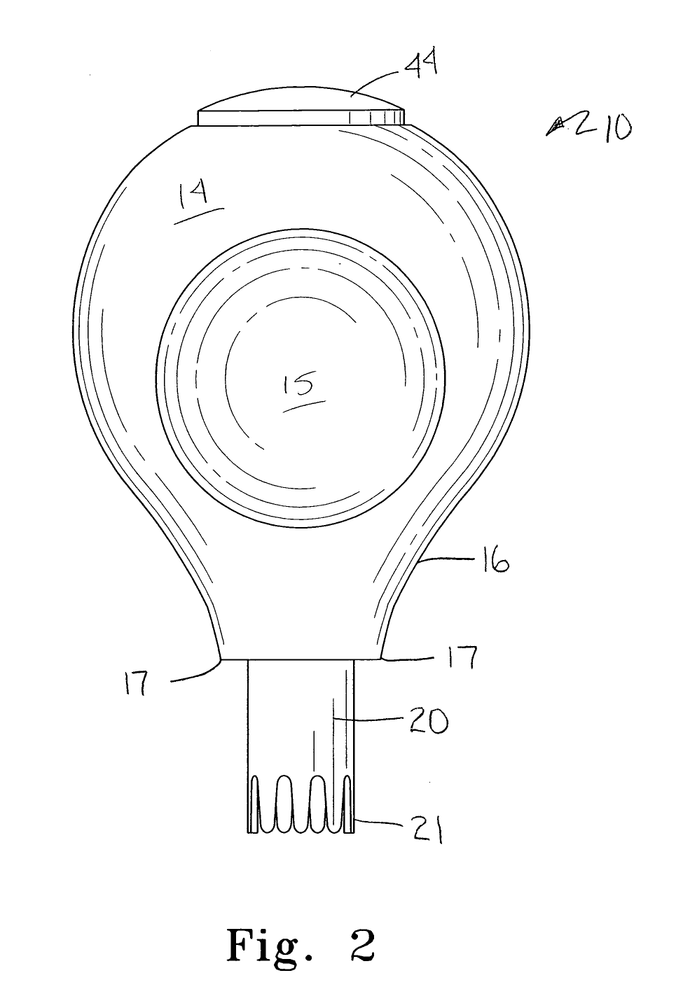

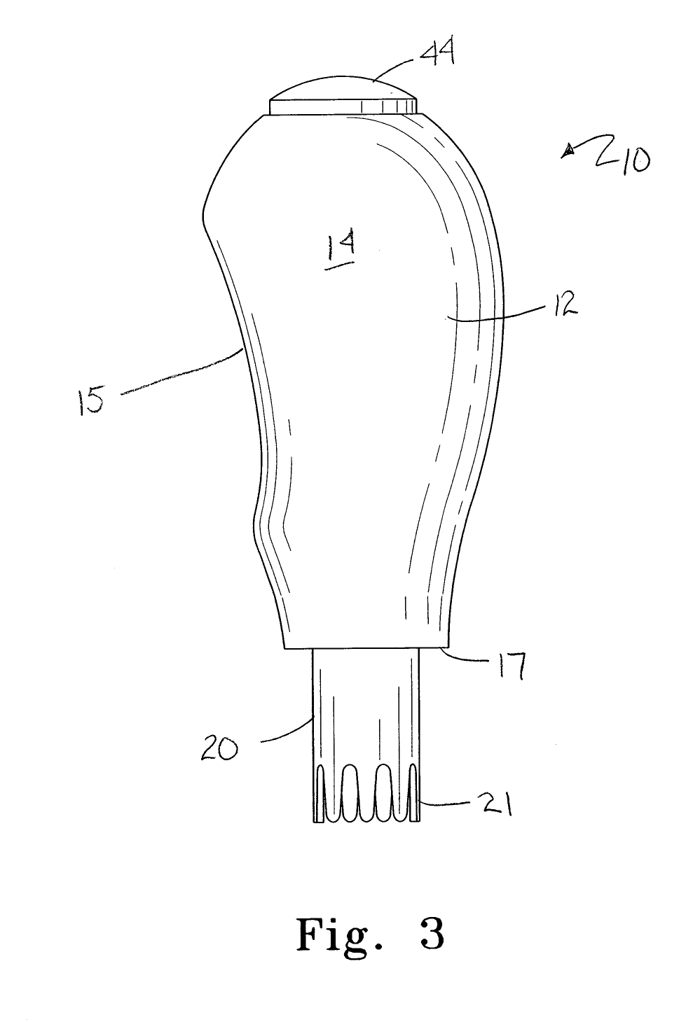

As shown in FIGS. 2 and 3, the handle 12 includes an integral taper 16 extending from the body 14 and leading into a shoulder 17. The shoulder 17 may be integrally formed, as shown, made of the same materials as the body 14 of handle 12, including resilient material, if desired. Alternatively, the shoulder 17 may be a cap (not shown) used to mount to the body 14 at the taper to form the shoulder 17. Such a cap might be a metal ringed-component which secures to the handle 12, serves to protect the resilient layer from being easily peeled from the body, and assists in securing the cutting member 20 to the handle 12.

With reference to FIGS. 1-3, the cutting member 20 can be more readily understood. The cutting member 20 is preferably a cylindrical metal component secured at one end within the molded body 14 of handle 12 and extending outward (as measured from the shoulder 17) no more than 1½ inches (about 3.7 cm). Preferably, the cutting member 20 is stainless steel and extends no more than one-half inch (about 1.3 cm). The other end of cutting member 20 includes a crenellated cutting edge 21. However, the cutting edge 21 may be of any configuration which is suitable for cutting into the flesh of a fruit, such as a strawberry.

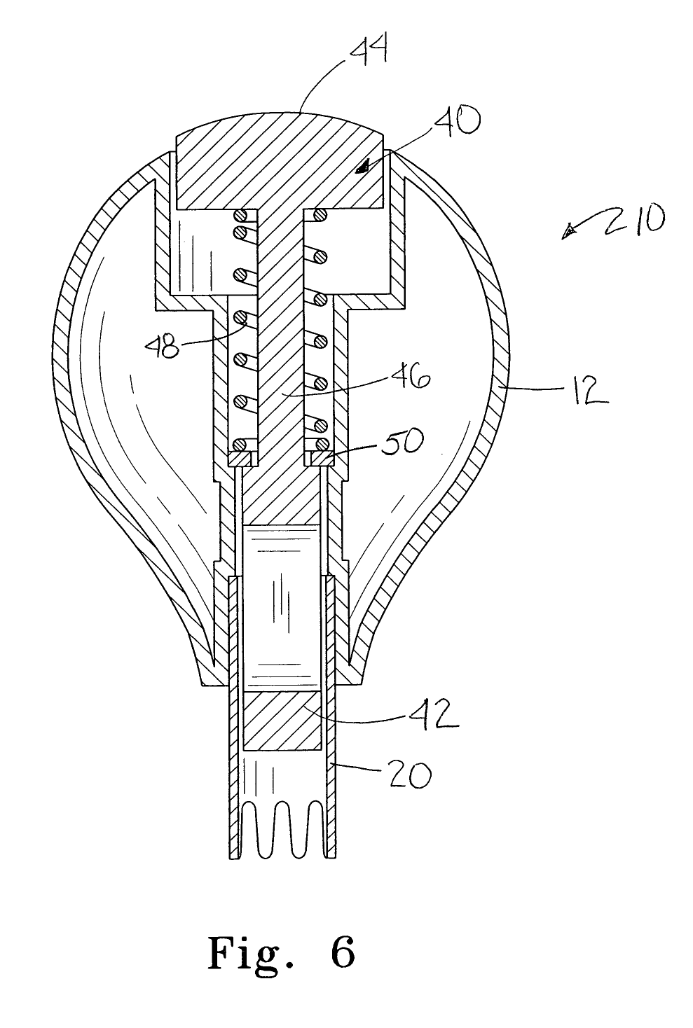

Referring now to FIGS. 6-8, the ejector mechanism can be more readily understood. The ejector mechanism is comprised of an actuator 40 having a discharging member 42 at one end. Preferably, the actuator 40 also comprises a push-button 44 and a shaft 46 which couples to the discharging member 42. The discharging member 42 resides within the hollow of the cutting member 20 at a position back far enough to allow ample insertion of the cutting member 20 into a food. The shaft 46 and push-button 44 of the actuator 40 reside in the handle 12. The push-button 44 is accessible from the top of the handle 12, as shown in FIG. 1.

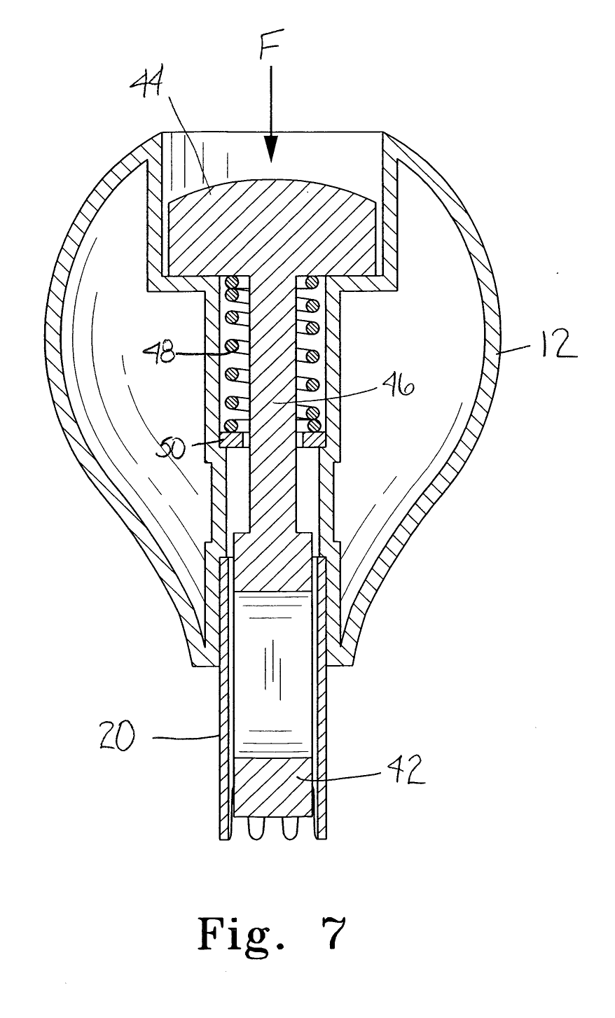

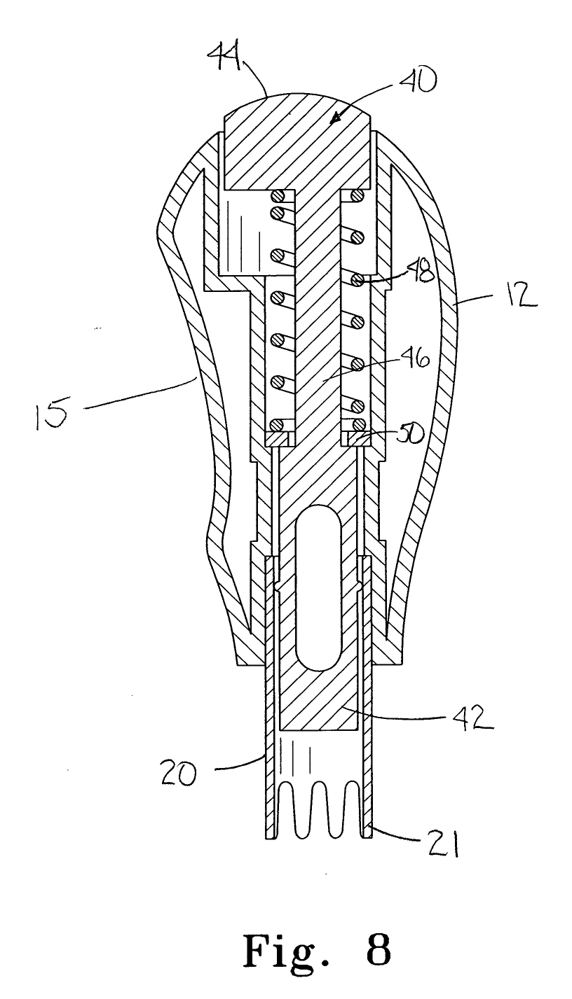

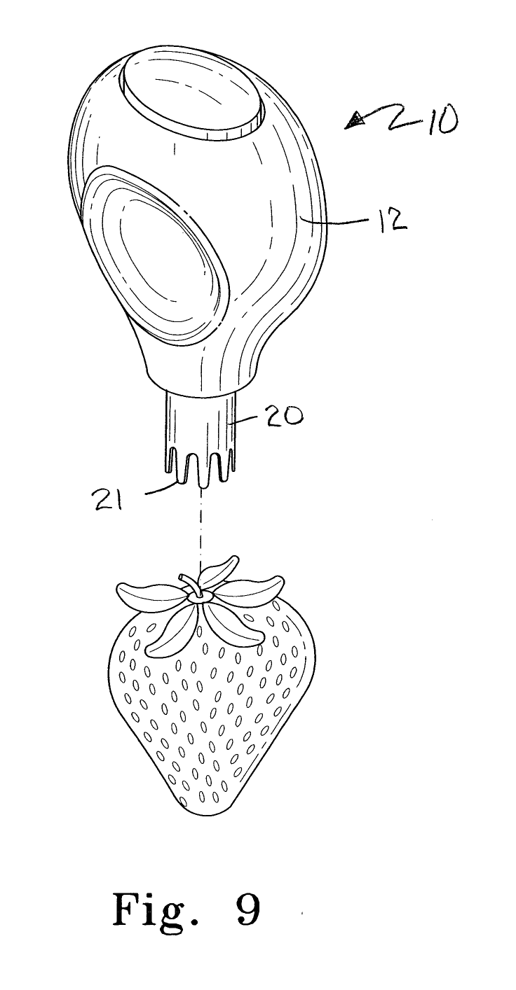

When depressed (force (F)), the push-button 44 advances the shaft 46, which in turn advances the discharging member 42 to an extended position proximate the crenellated end of the cutting member 20 (FIG. 7). A spring 48 or other biasing member, positioned between a shoulder 50 within the handle 12 and the push-button 44, returns the actuator 40 and discharging member 42 to the retracted position (FIGS. 6 and 8) when the depressing force (F) is removed.

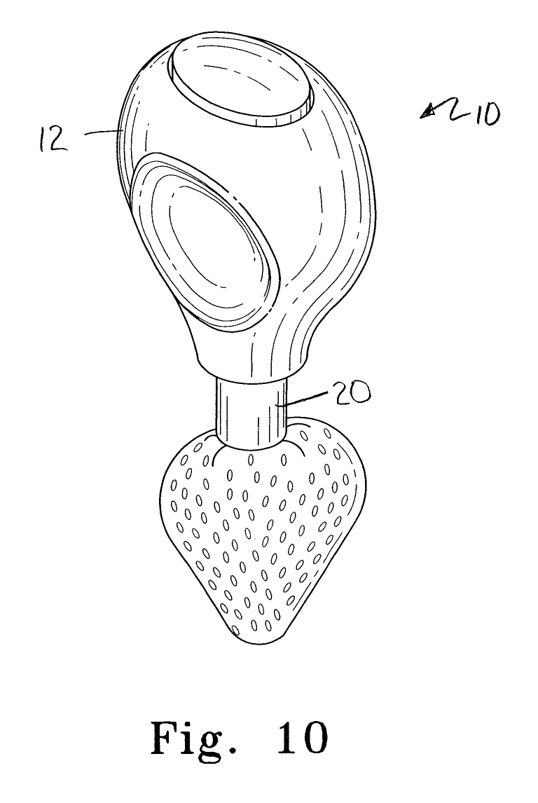

Referring to FIGS. 9-11, a possible use for the present huller 10, the coring of a strawberry, is illustrated. The huller 10 is first positioned to penetrate a strawberry by placing the cutting member 20 about the stem of the fruit. A small amount of force on the huller 10 handle 12 toward the strawberry, with or without a twisting motion, will drive the cutting edge 21 of the cutting member 20 into the fruit. The cutting member 20 will continue to penetrate the berry until the force is stopped or until the shoulder 17 of the handle 12 abuts the fruit. Retraction of the cutting member 20, with or without twisting, will withdraw the strawberry stem, the leaves surrounding the stem, and a small portion of the strawberry flesh where the stem is attached.

The shoulder 17 and the shortness of the cutting member 20 cooperate to prevent complete penetration of the fruit by huller 10. These features avoid a complete coring of the fruit, a process which unnecessarily removes edible flesh.

Once extracted from the fruit, depressing the push-button 44 at the top of the body 14 by a force (F), as shown in FIG. 11, will serve to eject the cored portion of the fruit into a suitable container.

In final construction, the huller is comprised of materials which are readily washable, and preferably dishwasher safe. The connections between the handle 12 and cutting member 20 should be sufficiently sealed to minimize contamination from cross-uses and prevent water penetration.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A hulling device comprising:
an ergonomic handle;
a tubular cutting member having a first end for cutting and being attached to the handle at a second end;
a discharging mechanism positioned within the tubular cutting member; and
an actuator coupled to the discharging mechanism and capable of moving the discharging mechanism, with the application of a force on the actuator, from a retracted position proximate the second end of the tubular cutting member to an extended position proximate the first end of the tubular cutting member.

2. The hulling device of claim 1, wherein the tubular cutting member has a length less than a length of the handle.

3. The hulling device of claim 1, further comprising a biasing member coupled to the actuator such that the discharging mechanism is automatically returned to the retracted position when the force is removed.

4. The hulling device of claim 1, further comprising a biasing member coupled to the actuator, wherein the biasing member opposes the force applied to the actuator.

5. The hulling device of claim 3, wherein the biasing member is a spring and the actuator and the spring reside in the handle.

6. The hulling device of claim 4, wherein the biasing member is a spring and the actuator and the spring reside in the handle.

7. The hulling device of claim 1, wherein the length of the tubular cutting member prevents the cutting member from cutting substantially through a food.

8. The hulling device of claim 7, wherein the tubular cutting member is less than one and one-half (1½) inches in length.

9. The hulling device of claim 1, wherein the tubular cutting member is fixed to the handle.

10. The hulling device of claim 1, wherein the handle is covered at least in part by a thermoplastic elastomer (TPE) material.

11. The hulling device of claim 10, wherein the TPE material comprises SANTOPRENE.

12. The hulling device of claim 1, wherein the cutting member is attached to the handle at a shoulder, wherein the shoulder stops penetration of the food at the length of the cutting member.

13. The hulling device of claim 12, wherein the tubular cutting member is less than one and one-half (1½) inches in length.

14. A huller for small fruit comprising:
an ergonomic handle;
a tubular cutting member having a cutting edge at a first end and attached to the handle at a second end, wherein the cutting member is capable of being inserted into a fruit or similar food item to a depth, a fixed stop for halting the depth of the cutting end, wherein the depth is less than a distance through the fruit;
a discharging mechanism positioned within the tubular cutting member; and
an actuator coupled to the discharging mechanism and capable of moving the discharging mechanism, with the application of a force on the actuator, from a retracted position proximate the second end of the tubular cutting member to an extended position proximate the first end of the tubular cutting member.

15. A huller for small fruit as described in claim 14, wherein the fixed stop comprises a shoulder at the attachment between the cutting member and the handle.

16. A huller for small fruit as described in claim 15, wherein the length of the tubular cutting member prevents the cutting member from cutting substantially through the fruit.

17. The huller for small fruit as described in claim 16, wherein the tubular cutting member is less than one and one-half inches (1½″) in length.

18. The huller for small fruit as described in claim 14, wherein the handle is covered at least in part by a thermoplastic elastomer (TPE) material.

19. The huller for small fruit as described in claim 18, wherein the TPE material comprises SANTOPRENE.

20. The huller for small fruit as described in claim 14, wherein the ergonomic handle comprises a depressed area for better grasping of the huller.
